(19) United States
(12) Patent Application Publication
(10) Pub. No.: US 2024/0291795 A1
(43) Pub. Date: Aug. 29, 2024

(54) SYSTEM AND METHOD TO MEDIATE SOCIAL MEDIA PLATFORMS AUTOMATICALLY FOR USER SAFETY

(71) Applicant: UNIVERSITY OF SOUTH CAROLINA, COLUMBIA, SC (US)

(72) Inventors: MANAS GAUR, COLUMBIA, SC (US); BIPLAV SRIVASTAVA, CHAPIN, SC (US)

(21) Appl. No.: 18/588,120

(22) Filed: Feb. 27, 2024

Related U.S. Application Data
(60) Provisional application No. 63/487,318, filed on Feb. 28, 2023.

(51) Int. Cl. H04L 51/52; G06Q 50/00; H04L 51/21

(52) U.S. Cl. CPC H04L 51/52; G06Q 50/01; H04L 51/21

(57) ABSTRACT

The disclosure deals with a system and method for mediating social media platforms automatically for user safety, including in particular for automatically or semi-automatically mediating social media platforms for user safety. People meet on online platforms and discuss a variety of topics. Moderators associated with those platforms play an important role in making the platform convenient and safe to users. This disclosure addresses detecting users who can act as potential moderators of an online group of support seekers and support providers in an online social media platform operating on the Internet. Such users are classified to identify the class of supportive users and class of non-supportive users of an online group. Received suggestions and other acquired data are used to identify a potential moderator for the online group. Acquired data on supportive and non-supportive users, as well as on harmful users, is then automatically supplied to the moderator.

### PRIORITY CLAIM

63/487,318 The present application claims the benefit of priority of U.S. Provisional Patent Application No. 63/487,318, filed Feb. 28, 2023, titled System and Method to Mediate Social Media Platforms Automatically for User Safety, and which is fully incorporated herein by reference for all purposes.

### BACKGROUND OF THE PRESENTLY DISCLOSED SUBJECT MATTER

63/487,318 The presently disclosed subject matter generally deals with system and methodology subject matter for mediating social media platforms, and in particular for automatically or semi-automatically mediating social media platforms for user safety.

People meet on online platforms and discuss a variety of topics. Moderators associated with those platforms play an important role in making the platform convenient and safe to users. Several functions of such a mediator mechanism for example include pointing to related information faster and intervening in case of violations or potential harm.

Currently, moderators are often either participants who have volunteered or employees of the associated platform operator. Some of the herewith recognized challenges of such arrangements are that moderators who are volunteers may have unknown incentives. Further, in execution, they may be relatively slow or too slow to moderate. Also, there is an overriding need and/or desire to make platforms safe.

Examples of published US patent documents (issued patents and published applications) which relate to various monitoring, testing, evaluating, controlling, and/or assisting methodologies, and some of which relate to a social media context, include U.S. Pat. Nos. 10,672,029; 10,169,733; 10,079,911; 9,846,916; 9,536,049; 9,318,108; 9,262,936; 9,176,149; 8,402,094; and 6,823,363; and US Publication Nos. 20130332545; and 20110289432.

Thus, the presently disclosed subject matter addresses the need for creating automated (or at least semi-automated) mediators, because existing approaches do not provide automated/semi-automated methods to create a mediator.

### SUMMARY OF THE PRESENTLY DISCLOSED SUBJECT MATTER

The presently disclosed subject matter generally deals with system and methodology subject matter for mediating social media platforms, and in particular for automatically or semi-automatically mediating social media platforms for user safety.

More specifically, presently disclosed subject matter relates providing a conversation agent and/or a “chatbot” that moderates a platform. For users, such technology would suggest groups, contents, and moderators. For the platform (i.e., the platform operators), the technology can detect moderators. For the moderator perspectives, the technology can help detect users who are either helpful and harmful, to be appropriately managed.

As will be understood by those of ordinary skill in the art, such technology would provide Automated Moderators (AMs) which can respond to issues faster and at scale. Another benefit is that the provided AMs can be unbiased, while also reducing costs to make online platforms safe. The potential economic benefits could be relatively large given the size of the marketplace presently involving social media generally. Within such context, there can also be a number of different areas of application for the technology, such as including (but not limited to) health, crisis management, economic activity (proposal formation), sports (team formation), and education (peer tutoring).

In one exemplary embodiment disclosed herewith, a method is for detecting users who can act as potential moderators of an online group of support seekers and support providers in an online social media platform operating on the Internet. Such method preferably may comprise classifying users to identify the class of supportive users and class of non-supportive users of an online group; identifying the class of users comprising support providers of the online group selected by support seekers of the online group for interaction; monitoring interactions between support seekers and the selected support providers, and storing votes thereafter given by support seekers on the class of supportive users within the selected class of support providers; receiving suggestions for moderator position of the online group from both the support seekers and from the class of support providers selected by the support seekers for interaction; and combining the received suggestions with the stored votes to identify at least one potential moderator for the online group.

Another exemplary presently disclosed method relates to a method for operation of an automated moderator which can connect support-seeking users with support giver users of an online group of support seeker and support provider users in an online social media platform operating on the Internet. Such method preferably may comprise in the context of the discussion subject matter of the online group, classifying users to identify the class of supportive users and class of non-supportive users of the online group; identifying the class of users comprising support providers of the online group selected by support seekers of the online group for interaction; monitoring interactions between support seeker users and support provider users to collect data comprising feedback from support seeker users about support provider users who have helped them, and data comprising agreements and disagreements with others, and volume of participation in discussion; applying rules to the collected data to recommend a user as moderator if feedback is high and participation is high, and to not recommend a user as moderator if disagreement is high; and contacting the potential moderator and establishing the potential moderator as the moderator in the moderator position for the online group.

It is to be understood that the presently disclosed subject matter equally relates to associated and/or corresponding systems, devices, and apparatuses.

Other exemplary aspects of the present disclosure are directed to systems, apparatus, tangible, non-transitory computer-readable media, user interfaces, memory devices, and electronic devices for automated mediation technology. To implement methodology and technology herewith, one or more processors may be provided, programmed to perform the steps and functions as called for by the presently disclosed subject matter, as will be understood by those of ordinary skill in the art.

Another exemplary embodiment of presently disclosed subject matter relates to a system a memory comprising instructions for detecting users who can act as potential moderators of an online group of support seekers and support providers in an online social media platform operating on the Internet; and a processor configured to execute the instructions. Such instructions are preferably to classify users to identify the class of supportive users and class of non-supportive users of an online group; identify the class of users comprising support providers of the online group selected by support seekers of the online group for interaction; monitor interactions between support seekers and the selected support providers, and storing votes thereafter given by support seekers on the class of supportive users within the selected class of support providers; receive suggestions for moderator position of the online group from both the support seekers and from the class of support providers selected by the support seekers for interaction; and combine the received suggestions with the stored votes to identify at least one potential moderator for the online group.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 illustrates in block diagram format the detailed system architecture for an exemplary presently disclosed embodiment for designing an exemplary mediator for a community-based platform for user-safety in the context of mental healthcare;

FIG. 2 illustrates in block diagram format an exemplary presently disclosed embodiment of a Reddit-based moderator finding supportive users on health topics mentioned by user seeking help, with focus on Covid19-related events;

FIG. 3 illustrates in block diagram format the runtime view of an exemplary automated moderator in accordance with the present disclosure;

FIG. 4 illustrates in block diagram format an exemplary presently disclosed automated mediator Task 1, relating to Identifying users who are supportive or non-supportive on a community-based platform;

FIG. 5 illustrates in block diagram format presently disclosed exemplary granular architecture to develop a model for user-type classification to support the automated mediator Task 1 represented in FIG. 4;

FIG. 6 illustrates in block diagram format an exemplary presently embodiment related to support-seeking users, to detect moderators based on their engagement, helpfulness, and useful references/recommendations;

FIG. 7 illustrates in block diagram format an exemplary presently embodiment related to moderators, for detecting users who are either helpful (supportive) or harmful; and

FIGS. 8 through 12 respectively illustrate different presently disclosed embodiments of exemplary user interfaces, for use in accordance with presently disclosed subject matter, and relating to association of support seekers with support providers, with FIG. 8 representing an exemplary “Sign-In” interface, with FIG. 9 representing exemplary submission of a question; with FIG. 10 representing exemplary submission of a question for a particular previously established category; with FIG. 11 representing an exemplary response thread to a submitted exemplary question; and with FIG. 12 representing an exemplary response thread to a submitted exemplary question with exemplary possible flagging options.

Repeat use of reference characters in the present specification and drawings is intended to represent the same or analogous features, elements, or steps of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to system and methodology subject matter for mediating social media platforms, and in particular for automatically or semi-automatically mediating social media platforms for user safety.

Regarding solution steps, from a user perspective, the presently disclosed technology can suggest groups, contents, and moderators. The presently disclosed mediator system would first take as input the name of the community (e.g., Reddit) where the user would like to discuss the problem and the description of the problem. Secondly, the system would extract event entities and other generic entities to form a query to search for supportive communities (for example: mental health and Covid19 in embodiment illustrations herewith). Thirdly, a query function can be used to suggest groups of users along with their content to the user seeking help. Further, users in the suggested groups are also described with the following metadata:
A. Name of their community (or communities)
B. The label of the user (supportive, informative, or expressing similar problem)
C. Whether the recommended user is a moderator or not.

Feedback to system can include such as the following:
a. The user seeking help can provide feedback to the system to create a candidate set of users who have the potential to be moderators, and
b. Criteria: “how helpful, supportive, and engaging helpers were” with the user seeking help.

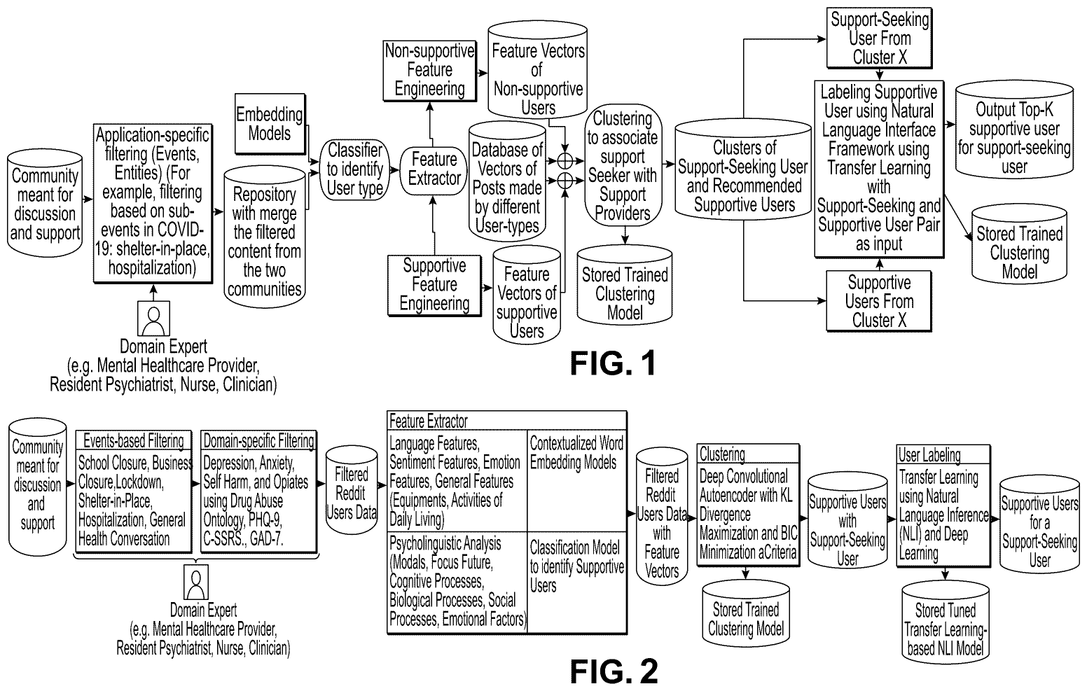

FIG. 1 illustrates exemplary system architecture for an embodiment for health related subject matter. In particular, FIG. 1 illustrates in block diagram format the detailed system architecture for an exemplary presently disclosed embodiment for designing an exemplary mediator for a community-based platform for user-safety in the context of mental healthcare. For example, people suffering mental health conditions may ask explicit or implicit questions on community-based platforms, and those queries can be categorized into broad themes of medication, treatment, and services.

FIG. 2 illustrates in block diagram format an exemplary presently disclosed embodiment of a Reddit-based moderator finding supportive users on health topics mentioned by user seeking help, with focus on Covid19-related events. More particularly, such FIG. 2 represents presently disclosed subject matter for designing the mediator for a community-based platform for user-safety in the context of mental healthcare with feature descriptions and intermediate stored clustering and NLI-classification model.

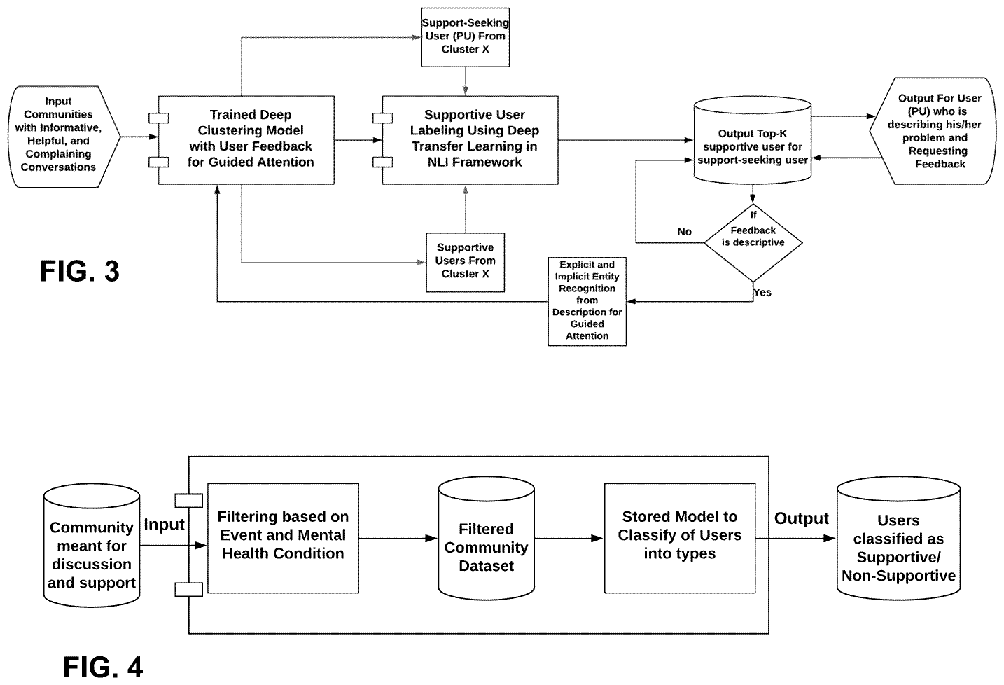

FIG. 3 illustrates in block diagram format the Runtime coding view of an exemplary automated moderator in accordance with the present disclosure. FIG. 3 also represents architecture of the mediator in Runtime after deployed in community-based platform for user-safety.

FIG. 4 illustrates in block diagram format an exemplary presently disclosed automated mediator Task 1, relating to Identifying users who are supportive or non-supportive on a community-based platform.

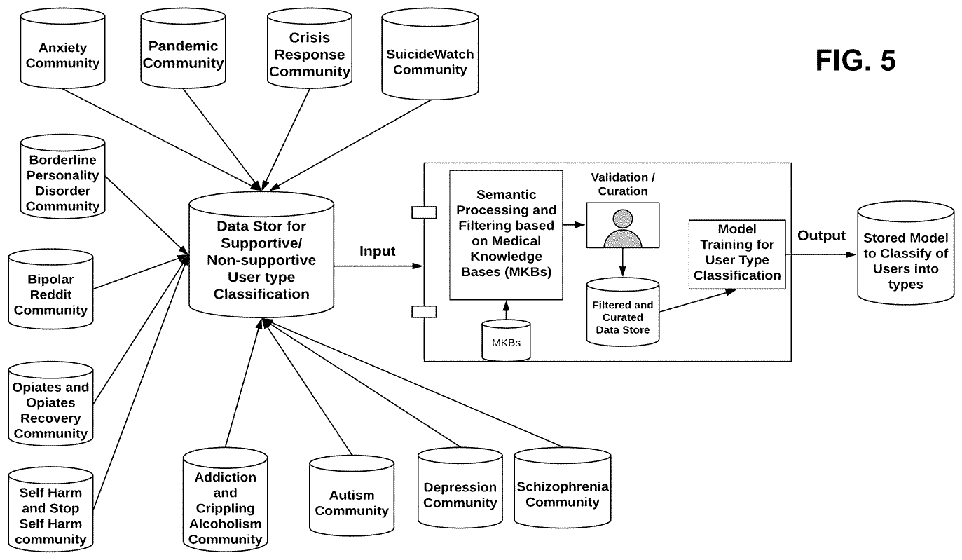

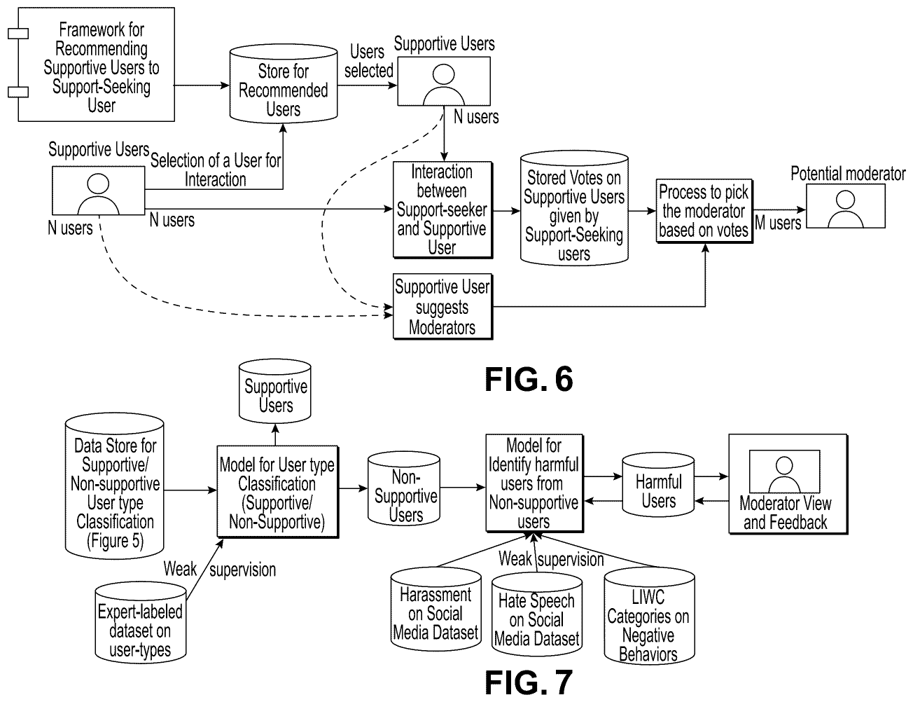

FIG. 5 illustrates in block diagram format presently disclosed exemplary granular architecture to develop a model for user-type classification to support the automated mediator Task 1 represented in FIG. 4.

Regarding solution steps, from a platform perspective, the presently disclosed technology can detect moderators. Thought of another way, the presently disclosed technology can assist in detecting users who would be good candidates for fulfilling a moderator role.

In general, the role of moderators is well understood in the industry. Online platforms like Reddit enable users to build communities and converse about diverse topics and interests. However, with the increasing number of users, there are posts of disturbing comments containing profanity, harassment, and hate speech, otherwise known as toxic comments. Moderators often struggle with managing the safety of discussions in online communities. To address these issues, it is needed to detect toxic comments.

The presently disclosed technology can gather Data 1=Collect feedback from users about users who have helped them and Data 2=Assess users based on agreements and disagreements with others, and volume of participation in discussion. The presently disclosed technology can use or apply rules on Data 1 and Data 2 to recommend some users as moderators.

Examples of or illustrative presently disclosed rules may include:
Recommend user_i, if feedback is high and participation is high (participative user), and
Do not recommend user_i, participation is high and disagreement is high (toxic user).

FIG. 6 illustrates in block diagram format an exemplary presently embodiment related to support-seeking users, to detect moderators (candidates to be moderators) based on their engagement, helpfulness, and useful references/recommendations.

Regarding solution steps, from a moderator (or potential moderator) perspective, the presently disclosed technology can help detect users who are either or helpful or harmful.

In general, it is desirable to minimize negative exposure on the users seeking help, it is essential to identify users who are helpful (supportive, informative, or expressive similar problems) and filter out harmful users. Current practice often for detecting whether a user is helpful or harmful is by performing such consideration manually by the moderators of the community, which is time-consuming and error-prone.

Active steps potentially available through practice of the presently disclosed technology may include:
1. Use a classifier through weak-supervision to identify the supportive and non-supportive user. The classifier is a stacked sequence of Google's Universal Sentence Encoder and Logistic Regression leverage expert-labeled dataset of the supportive and non-supportive user on online mental health communities.
2. Use a second weak-supervision classifier which would take as input users who are classified as non-supportive and use a labeled dataset on harassment and hate speech, along with LIWC (Linguistic Inquiry and Word Count) categories on negative behaviors to identify harmful users.
3. The users identified as harmful will be visible to the moderator of the community and feedback would be desired. The feedback would be a description from which important entities will be extracted and be used per the module which identifies harmful users from non-supportive.

FIG. 7 illustrates in block diagram format an exemplary presently embodiment related to moderators, for detecting users who are either helpful (supportive) or harmful. Discoverability or detection is for some embodiments a factor of having knowledge of the features (i.e., focus) of the social platform.

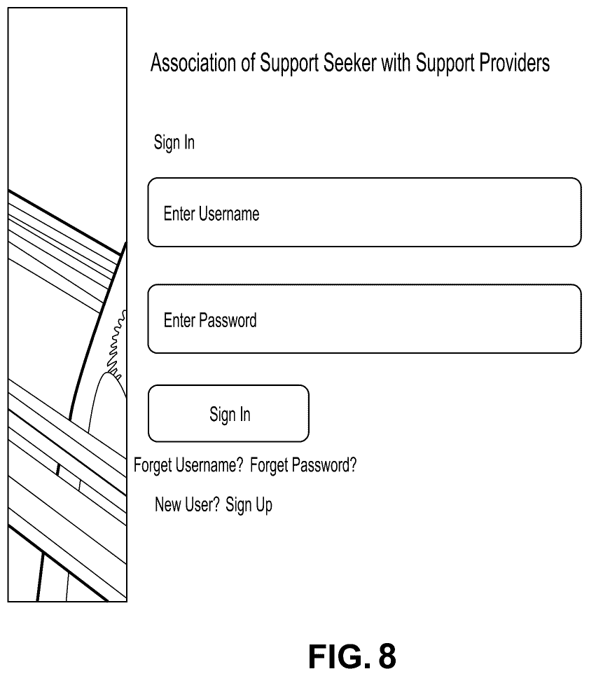

In one exemplary context of user interfaces, a user comprising a support seeker can connect with support providers through the submission of an inquiry to the social platform or gate. FIGS. 8 through 12 respectively illustrate different presently disclosed embodiments of exemplary user interfaces, for use in accordance with presently disclosed subject matter, and relating to association of support seekers with support providers. As shown, some offer the user the opportunity to select a social platform, for example, Reddit, while others provide such feature and/or the opportunity for the user to specify/choose a category, for example, Addiction, Depression, or Anxiety. Some examples offer a secured sign-in feature. It may be typical for many of such examples to use a query box or similar by which a user may specify their question or discussion of interest.

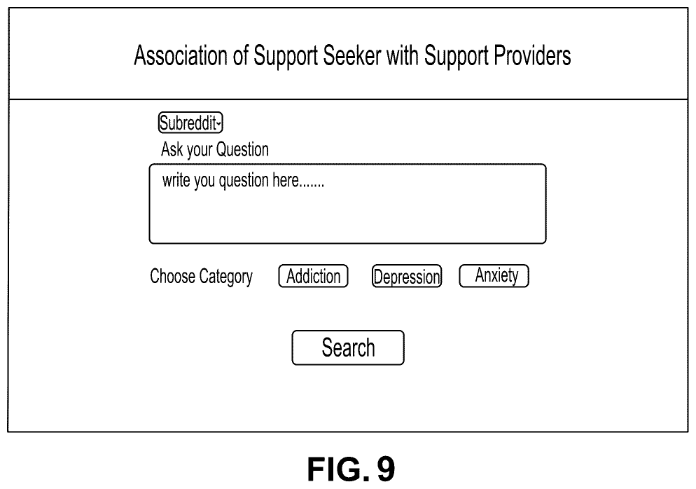

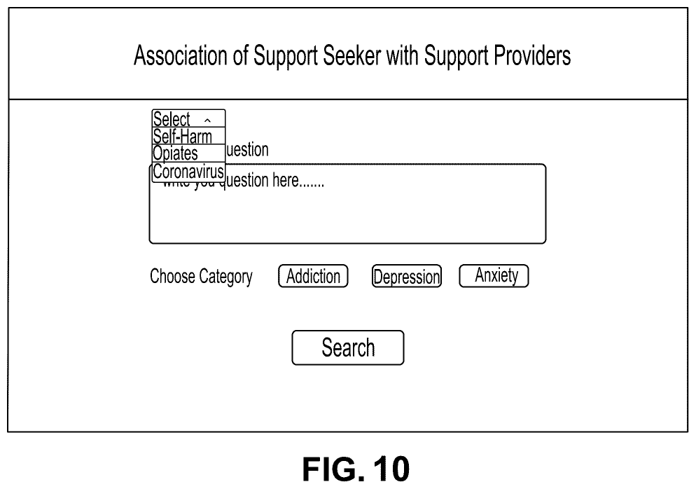

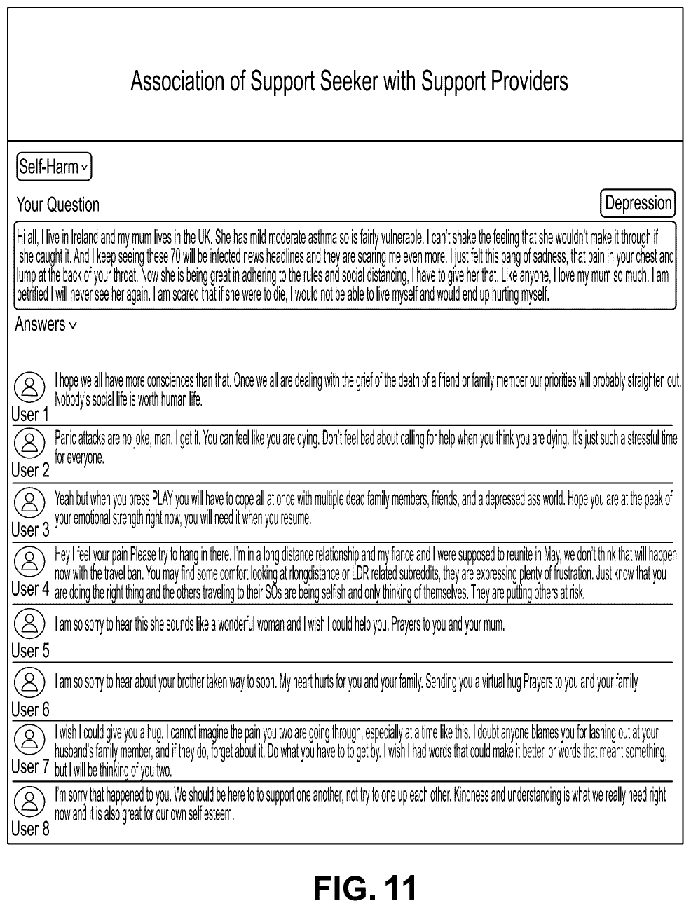

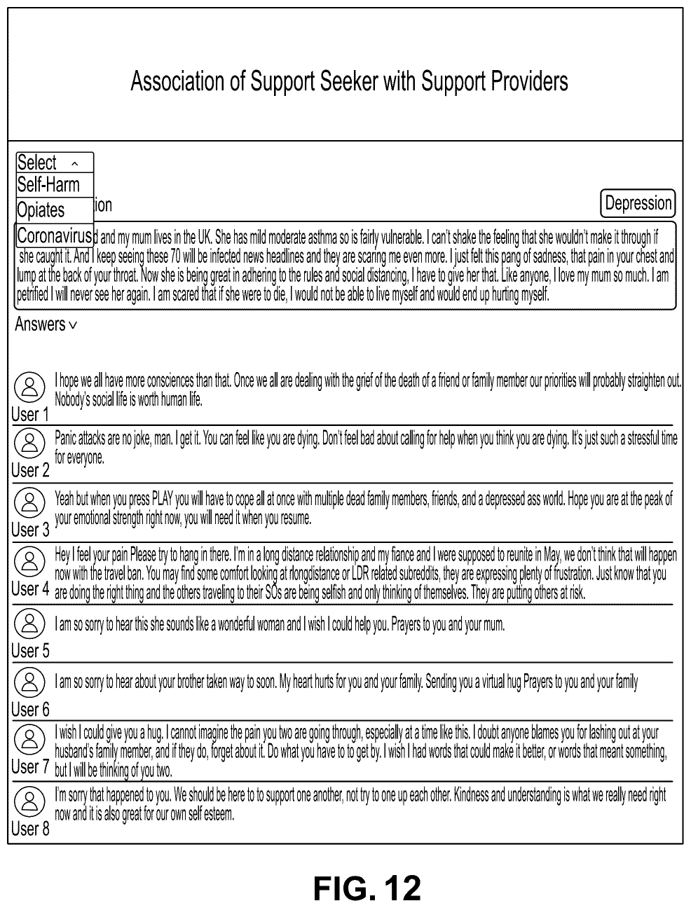

More particularly, FIG. 8 represents an exemplary “Sign-In” interface. FIG. 9 represents exemplary submission of a question. FIG. 10 represents exemplary submission of a question for a particular previously established category. FIG. 11 represents an exemplary response thread to a submitted exemplary question. FIG. 12 represents an exemplary response thread to a submitted exemplary question with exemplary possible flagging options.

While certain embodiments of the disclosed subject matter have been described using specific terms, such description is for illustrative purposes only, and it is to be understood that changes and variations may be made without departing from the spirit or scope of the subject matter.

What is claimed is:

1. A method for detecting users who can act as potential moderators of an online group of support seekers and support providers in an online social media platform operating on the Internet, the method comprising:
classifying users to identify the class of supportive users and class of non-supportive users of an online group;
identifying the class of users comprising support providers of the online group selected by support seekers of the online group for interaction;
monitoring interactions between support seekers and the selected support providers, and storing votes thereafter given by support seekers on the class of supportive users within the selected class of support providers;
receiving suggestions for moderator position of the online group from both the support seekers and from the class of support providers selected by the support seekers for interaction; and
combining the received suggestions with the stored votes to identify at least one potential moderator for the online group.

2. The method according to claim 1, wherein classifying users comprises use of weak-supervision to identify the supportive users and non-supportive users.

3. The method according to claim 2, wherein classifying users comprises use of a stacked sequence of a Universal Sentence Encoder and Logistic Regression leverage expert-labeled dataset of the supportive and non-supportive users on online mental health communities.

4. The method according to claim 1, further comprising contacting the potential moderator and establishing the potential moderator as the moderator in the moderator position for the online group.

5. The method according to claim 4, further comprising informing the moderator of identified supportive users and non-supportive users.

6. The method according to claim 5, further comprising further classifying previously identified non-supportive users using a labeled dataset on harassment and hate speech to identify harmful users.

7. The method according to claim 6, further comprising informing the moderator of identified harmful users.

8. The method according to claim 6, further comprising further classifying previously identified non-supportive users using Linguistic Inquiry and Word Count (LIWC) categories on negative behaviors to identify additional harmful users.

9. The method according to claim 8, further comprising informing the moderator of all identified harmful users as distinguished from those only identified as non-supportive users.

10. The method according to claim 1, wherein combining suggestions with votes includes:
collecting data comprising feedback from users about users who have helped them, and data comprising agreements and disagreements with others, and volume of participation in discussion, and
applying rules to collected data to recommend a user if feedback is high and participation is high, and to not recommend a user if participation is high and disagreement is high.

11. The method according to claim 1, wherein the online group is focused on at least one discussion topic including at least one of the areas of health, crisis management, economic activity, sports, and education.

12. A system, comprising:
a memory comprising instructions for detecting users who can act as potential moderators of an online group of support seekers and support providers in an online social media platform operating on the Internet; and
a processor configured to execute the instructions to:
classify users to identify the class of supportive users and class of non-supportive users of an online group;
identify the class of users comprising support providers of the online group selected by support seekers of the online group for interaction;
monitor interactions between support seekers and the selected support providers, and storing votes thereafter given by support seekers on the class of supportive users within the selected class of support providers;
receive suggestions for moderator position of the online group from both the support seekers and from the class of support providers selected by the support seekers for interaction; and
combine the received suggestions with the stored votes to identify at least one potential moderator for the online group.

13. The system according to claim 12, wherein instructions to classify users further comprises use of weak-supervision to identify the supportive users and non-supportive users.

14. The system according to claim 13, wherein instructions to classify users further comprises use of a stacked sequence of a Universal Sentence Encoder and Logistic Regression leverage expert-labeled dataset of the supportive and non-supportive users on online mental health communities.

15. The system according to claim 12, further comprising instructions to contact the potential moderator and to establish the potential moderator as the moderator in the moderator position for the online group.

16. The system according to claim 15, further comprising instructions to inform the moderator of identified supportive users and non-supportive users.

17. The system according to claim 16, further comprising instructions to further classify previously identified non-supportive users a labeled dataset on harassment and hate speech and using Linguistic Inquiry and Word Count (LIWC) categories on negative behaviors to identify additional harmful users.

18. The system according to claim 17, further comprising informing the moderator of all identified harmful users as distinguished from those only identified as non-supportive users.

19. A method for operation of an automated moderator which can connect support-seeking users with support giver users of an online group of support seeker and support provider users in an online social media platform operating on the Internet, the method comprising:
in the context of the discussion subject matter of the online group, classifying users to identify the class of supportive users and class of non-supportive users of the online group;
identifying the class of users comprising support providers of the online group selected by support seekers of the online group for interaction;
monitoring interactions between support seeker users and support provider users to collect data comprising feedback from support seeker users about support provider users who have helped them, and data comprising agreements and disagreements with others, and volume of participation in discussion;
applying rules to the collected data to recommend a user as moderator if feedback is high and participation is high, and to not recommend a user as moderator if disagreement is high; and
contacting the potential moderator and establishing the potential moderator as the moderator in the moderator position for the online group.

20. The method according to claim 19, wherein classifying users comprises use of an expert-labeled dataset of the supportive and non-supportive users on online communities in the context of the discussion subject matter of the online group.

21. The method according to claim 19, further comprising informing the moderator of identified supportive users and non-supportive users.

22. The method according to claim 21, further comprising further classifying previously identified non-supportive users using a labeled dataset on harassment and hate speech to identify harmful users.

23. The method according to claim 22, further comprising informing the moderator of identified harmful users.

24. The method according to claim 22, further comprising further classifying previously identified non-supportive users using Linguistic Inquiry and Word Count (LIWC) categories on negative behaviors to identify additional harmful users.

25. The method according to claim 24, further comprising informing the moderator of all identified harmful users as distinguished from those only identified as non-supportive users.

26. The method according to claim 19, wherein the online group is focused on at least one discussion topic including at least one of the areas of health, crisis management, economic activity, sports, and education.
